(19) United States
(12) Patent Application Publication
(10) Pub. No.: US 2005/0175339 A1
(43) Pub. Date: Aug. 11, 2005

(54) Dynamic broadband optical equalizer

(76) Inventors: Varda Herskowits, Petach-Tikva (IL); Antony J. Weiss, Tel-Aviv (IL); Menachem Tipris, Raanana (IL); Shmuel Levy, Kiryat-Tivon (IL)

Correspondence Address: WOLF, BLOCK, SCHORR & SOLIS-COHEN LLP, 250 PARK AVENUE, NEW YORK, NY, 10177, US

(21) Appl. No.: 10/506,859

(22) PCT Filed: Aug. 12, 2002
(86) PCT No.: PCT/IL02/00664

Related U.S. Application Data
(60) Provisional application No. 60/363,947, filed on Mar. 14, 2002.

(51) Int. Cl. H01S 3/00

(52) U.S. Cl. 398/1

(57) ABSTRACT

Apparatus for correcting distortion on an optical transmission link carrying a multiplicity of optical transmission channels, the apparatus comprising: an adjustable optical equalizer, through which a plurality of said channels pass; a field sampler that samples signals passing through said equalizer, such that a plurality of channels passing through the adjustable equalizer are separately sampled; and a controller that receives the samples, determines control parameters for the equalizer therefrom and adjusts the equalizer, responsive to said determined control parameters.

### RELATED APPLICATIONS

The present application claims the benefit under 119(e) of U.S. provisional application No. 60/363,947 filed Mar. 14, 2002 disclosure of which is incorporated herein by reference.

### FIELD OF THE INVENTION

The present invention relates to methods and apparatus for moderating distortion in optical pulses transmitted over an optical link of a communication network that are caused by dispersion of energy in the pulses during transmission over the link.

### BACKGROUND OF THE INVENTION

An optical communication network transmits digital data between a transmitter and a receiver in the network in the form of pulses of light, usually representing zeros and ones, that are transmitted between the transmitter and receiver via an optical link comprising optical fibers. At a given transmission rate, pulses in a pulse train transmitted by the transmitter are transmitted during temporally contiguous, sequential periods of time, referred to as repetition periods, having substantially a same duration that is determined by the transmission rate. Each pulse in the pulse train is transmitted during its own pulse repetition period. At transmission, each pulse has a well-defined shape and a pulse width equal to or smaller than the pulse repetition period, as a result of which its optical energy is substantially confined to its repetition period.

However, as a pulse propagates through an optical fiber it generally suffers attenuation and dispersion as a result of interaction of the pulse with the material from which the fiber is formed. Attenuation reduces an amount of energy in a light pulse while dispersion redistributes the pulse's energy and generally temporally spreads the pulse. The attenuation and dispersion that a pulse suffers during propagation over a fiber can change the pulse shape and/or amplitude to a degree that makes it difficult to identify which digital symbol the pulse represents. In addition, often, dispersion spreads the energy of a pulse to such an extent that after propagating over a length of fiber, energy from a pulse in a pulse train transmitted by a transmitter in the network appears in repetition periods of other pulses in the pulse train. The energy of the pulse is no longer confined to its own repetition period but is spread out to repetition periods of other pulses and mixes with the energy of the other pulses. The mixing of optical energy from different pulses in a same given repetition period increases the difficulty in identifying the symbol that the pulse originally transmitted in the given repetition period is intended to represent. The mixing of energy that interferes with symbol identification is referred to as inter-symbol interference (ISI).

Various types of interactions of the energy in an optical pulse with the material of the fiber over which it is transmitted generate dispersion and dispersion generated by a given type of interaction is generally identified and referred to by the given type of interaction. Among the types of dispersion that can affect optical pulses are, for example chromatic dispersion (CD), self phase modulation (SPM) and polarization mode dispersion (PMD).

Variation of the index of refraction of the material in a fiber with wavelength of light results in a variation of the phase velocity of light in the fiber as a function of wavelength and gives rise to chromatic dispersion. A pulse of light having a given pulse width comprises light at different wavelengths in a band of wavelengths having a bandwidth inversely proportional to the given pulse width. As a result, energy in a pulse of light that enters an optic fiber as a well formed pulse having a well defined temporal extent, spreads and is “chromatically dispersed”, as it travels along the fiber and light at the different wavelengths in the pulse propagate at different phase velocities.

For a given optical link, a major portion of chromatic dispersion is typically compensated or “equalized” using various relatively effective devices known in the art, such as dispersion compensating fibers. Some of the CD compensating devices are broad band devices designed to compensate chromatic dispersion in all channels of a communication network, e.g. all the channels in a WDM network. However, generally, compensation is not perfect for all channels comprised in a communication network bandwidth and a residual amount of chromatic dispersion remains. The residual chromatic dispersion (RCD) is a function of wavelength and varies in time as channels in the network are reconfigured and the ambient environment of the network changes. Residual chromatic dispersion in a communication network may often be as large as 0.5 ps/(km·nm) and changes in the residual chromatic dispersion are typically characterized by time constants of hours.

Since the bandwidth of light in a pulse of light increases as pulse width decreases, RCD becomes more disruptive of quality of communication as data transmission rates in a communication network increase and widths of pulses required to support the increased transmission rates decreases. For transmission rates in a communication network equal to or greater than about 40 Gbps, compensation of RCD is generally needed to provide acceptable quality communication over the network.

In SPM, intensity of the electric field in a light pulse changes the index of refraction of the material in an optic fiber through which the light pulse propagates. Since the electric field is not constant over the light pulse, different regions of the light pulse “see” different indices of refraction and therefore travel at different phase velocities. The different phase velocities result in SPM dispersion of energy in the pulse, which result in the chromatic dispersion pulse distortion effect.

Polarization mode dispersion (PMD) is a dominant source of time dependent dispersion that degrades quality of transmission in optical communication networks that transmit data at transmission rates equal to or in excess of about 10 Gbps. Birefringence of materials from which optical fibers in the network are formed generates PMD. Birefringence in an optical fiber is generally caused by the cross section of the fiber being deformed from a substantially circular shape to an elliptical shape. Various causes can contribute to fiber ellipticity. For example, inherent “ellipticity” of a fiber may be produced in sections of the fiber during its manufacture. A fiber may be subject to bending stresses that deform sections of the fiber during handling and deployment of the fiber. After deployment, a fiber very often is subject to random mechanical and/or thermal stresses that deform the fiber and change ellipticity of different sections of the fiber as the ambient environment of the fiber changes. As a result, ellipticity and concomitant birefringence of a fiber in an optical network is generally time dependent and a function of location along the fiber.

A section of fiber that is birefringent may generally be described as having two orthogonal axes, a “fast” axis and a “slow” axis. A component of light in a light pulse having polarization parallel to the fast axis propagates in the section of fiber with a phase velocity that is greater than a phase velocity at which a component of light in the pulse having a polarization parallel to the slow axis propagates. After propagation through the section of fiber a portion of energy in the pulse that travels at the slow phase velocity lags behind a portion of energy in the pulse that travels at the fast phase velocity. A difference in transit time through the section of fiber is conventionally referred to as a “differential group delay” and results in “polarization mode” dispersion of the energy in the pulse. At the interface between two consecutive birefringent sections having birefringent axes which are mutually rotated, a mode coupling effect occurs, whereby “fast” and “slow” traveling pulse portions intermix resulting in intermediate transit times. After propagating through a fiber comprised of a multiplicity of mutually rotated birefringent sections the pulse energy is continuously distributed over a spread of transit times representing the various delays. Time constants that characterize changes in PMD of a fiber in a communication network typically range from a few milliseconds to hours and magnitude of PMD for fibers exhibiting substantial PMD may range from 1-10 ps/km^{1/2}. Samples of the differential group delay for a length of fiber acquired over an extended period of time are generally characterized by a Maxwellian probability density function.

An article by M. Bohn, et. al. entitled “An Adaptive Optical Equalizer Concept for Single Channel Distortion Compensation” Proceedings of the 27^{th} European Conference on Optical Communication, Sep. 30, 2001, pp 210-211 describes adaptive combined GVD (Group Velocity Dispersion) and SPM (Self Phase Modulation) compensation for a single optical channel using a single filter. The article also shows compensation for a single channel for PMD (Polarization mode dispersion) and indicates that compensation for all three causes of distortion are possible. The filter concept is based on a lattice structure, which can be implemented as a cascade of symmetrical and asymmetrical Mach-Zehnder interferometers (MZI). The symmetrical MZIs function as directional couplers and the asymmetrical MZI function as delay and phase shift elements. An adaptive algorithm is used to determine tap weights for the filter. There is no indication that the system shown is applicable to multi-channel systems and no methodology for correcting dispersion in multi-channel systems is disclosed.

U.S. patent application Publication 2001/0055437 A1, the disclosure of which is incorporated herein by reference, describes a compensator that compensates PMD in a plurality of WDM channels in a WDM network. The method described in this publication is based on the thesis that the WDM channels need not be treated separately and “may still be treated equally as a whole, even in the high PMD regime, where the correlation bandwidth of the PMD vectors is less than the WDM channel spacing. This is in part based on the recognition that two or more WDM channels are not likely to be severely degraded by the PMD at any given time.” In fact, however, the channels are treated differently, due to the dispersive nature of the filters used.

Two embodiments are shown. One embodiment shows a first order PMD compensator through which all signals in a limited plurality of the WDM channels propagate. A polarization controller (PC) coupled to a polarization maintaining (PM) fiber is provided in the line through which the channels pass. The polarization controller “controls and adjusts polarization of light so that its output signal has a particular polarization. The controller is operable to set its output polarization in any desired polarization state and may operate in response to an external control signal. The PM fiber . . . is birefringent and has fixed orthogonal polarization axes. Hence as the polarization controller rotates the polarization of the input signal relative to the principal polarization axes of the PM fiber . . . a delay between the two orthogonal polarizations can be introduced through propagation through the PM fiber in each WDM channel.” In the disclosed embodiment the control signals are generated responsive to “a property of the combined WDM channels” and more particularly to the “total optical power of the combined WDM channels in the form of a modulated current or voltage” output from an optical detector.

A second embodiment, shown in FIG. 6, shows a multi-section compensator comprising a plurality of compensators (as used in the first embodiment) concatenated in series. A single optical detector and a single RF detector feed a signal to a feedback control circuit that controls the plurality of polarization controllers in the individual compensators. No methodology for processing the signal to adjust the compensators is shown.

An article by Yi Li et. al. entitled “Higher-order Error of Discrete Fiber Model and Asymptotic Bound on Multi staged PMD Compensation”, in J. Lightwave Technology, 18(9) pp. 1205, 2000, the disclosure of which is incorporated herein by reference, describes modeling an optic fiber as a concatenation of discrete birefringent sections each of which can be considered an elliptical waveplate. The model provides a Jones matrix for the fiber that predicts the PMD of the fiber and a measure of the accuracy of the predicted PMD. While the article describes a Multi-Staged PMD compensator for an optic fiber, which theoretically can be used to compensate errors in a long optical line, it does not give a method of providing multi-channel compensation of a given optical system whose physical properties are not known.

These last two references relate only to compensation for PMD. They do not claim to correct other forms of distortion. The Paper to Bohn, et al., on the other hand, relates to correction of multiple caused of distortion, but neither teaches nor describes a system that would make such corrections for multi-channel systems.

### SUMMARY OF THE INVENTION

An aspect of some embodiments of the present invention relates to providing a wideband adaptive optical equalizer (WAOE) for an optic fiber link in a communication network that supports a plurality of different optical channels. The WAOE moderates dispersion of energy in optical pulses transmitted via the optical link in a multiplicity, optionally, in all the optical channels supported by the network. In an embodiment of the invention, the WAOE operates on pulses from all the optical channels without de-multiplexing the pulses and correcting each of the channels separately. Optimally, moderation of dispersion in all channels is substantially transparent to the physical cause of the dispersion and substantially all types of dispersion, e.g. PMD, RCD, SPM, that affect quality of communication over the link are adaptively moderated.

In an exemplary embodiment of the present invention, a WAOE comprises a plurality of concatenated tunable optical filter units (TOFUs) through which a plurality, optionally all, channels transmitted via the link propagate. Each TOFU comprises a variable beam splitter and a predetermined constant or tunable differential delay element (TDE). Optionally, the beam splitter splits the beam based on the polarization of the beam. Alternatively, the splitting is not based on polarization. Alternatively, the beam splitter can be replaced by a polarization rotator, with differential delay being between two polarization directions of the rotated beam. Combinations of rotation and mixing can also be used. Alternatively, the delay element can be replaced by a differential phase shifter or a phase shift and delay can be used in series. Optionally, the WAOE comprises a monitor that samples pulses from a plurality of the channels that are transmitted over the link and through the WAOE to monitor at least one characteristic of the pulses. The control coefficients of the TOFU are determined responsive to the at least one characteristic so as to moderate pulse dispersion over the link for all the channels monitored. In some embodiments, all of the channels are monitored and the dispersion moderated for all of them.

In exemplary embodiments of the invention, the dispersion is moderated for all of the channels passing through the WAOE. In some implementations of the invention, the monitored characteristic is a single global parameter, characterizing all the channels passing through the WAOE. In others it is a vector with elements representing the at least one characteristic for individual elements.

In an embodiment of the invention, the individual channel characteristic is pulse shape. Optionally, the characteristic is a power spectrum of the pulses provided by an auto-correlation function determined for the pulses. Optionally, the auto-correlation function is determined using a method and apparatus described in PCT application PCT/IL02/00165, the disclosure of which is incorporated herein be reference.

According to an aspect of some embodiments of the present invention, control coefficients of the WAOE are determined responsive to a characteristic defined in terms of a cost function, metric or signal. As used herein the term “cost function” is meant to include any of a cost function, metric or other signal.

In some embodiments of the present invention, a cost function is determined responsive to data received from at least one receiver comprised in the network that receives pulses transmitted over the link in a plurality of the channels as to what symbols the received pulses most likely represent.

In some embodiments of the present invention, a cost function is determined responsive to a decision made by the at least one receiver as to what symbols the received pulses most likely represent.

In some embodiments of the present invention, a cost function is determined responsive to eye opening data for each channel. Alternatively or additionally it is responsive to a Q-factor derived from channel BER data. Optionally, the BER is measured by a component in the receiver, for example an FEC unit. Optionally, the BER signal itself forms the basis for the cost function. Optionally, the cost signal is any measurement, process or calculated number that is monotonic with or correlated with the BER. Optionally, a partial BER (failure of detection of ones or zeros) is used as the basis for the cost function. For an explanation of the meaning of BER and Q factor, see for example, Agrawal, G.P., Fiber-Optic Communication Systems, 2nd edition, pages 170-175.

In some embodiments of the invention, a training sequence is used to determine the settings for the correction network. Since the values received are known for such a sequence, the error measurements are easier to determine. Periodically, training sequences may be sent to allow for a periodic update of the correction network. Alternatively, such sequences may be requested when degeneration of the correction becomes apparent. In some embodiments of the invention, a training sequence is used either initially, periodically or when required to initialize the WAOE and correction is updated using the actual data carrying signals. Alternatively, only the data carrying signals are used.

In some embodiments of the present invention, an error signal is a measurement or processed signal that results from a correlation between any of the equalized signals and the unequalized signals. This method of determining error signals is described, for example in “Digital Communications”, by J. G. Proakis, Chapter 11, McGraw-Hill, New York, Fourth Edition, 2001.

In some embodiments of the present invention, a cost function is equal to a function, such as a sum, weighted sum or other function of error differences or other error indicators as noted above, determined for each of the channels. The sum is periodically updated and used to update the control coefficients. As used herein, the term error indicator relates to any of such individual channel metrics. In some embodiments of the present invention each channel is periodically polled and an error indicator determined from at least one received pulse waveform Pₖ in the channel. The cost function is then updated with respect to the polled error indicator for the channel and the control coefficients updated.

In some embodiments of the invention, the WAOE settings are continuously updated. In others, the settings are only updated when the cost function (or an error indicator for one or more channels) indicates a deterioration of the system below some level.

In some embodiments of the invention, the settings are intiialized by a user or host computer, independent of the cost function.

There is thus provided, in accordance with an exemplary embodiment of the invention, apparatus for correcting distortion on an optical transmission link carrying a multiplicity of optical transmission channels, the apparatus comprising:
an adjustable optical equalizer, through which a plurality of said channels pass;
a field sampler that samples signals passing through said equalizer, such that a plurality of channels passing through the adjustable equalizer are separately sampled; and
a controller that receives the samples, determines control parameters for the equalizer therefrom and adjusts the equalizer, responsive to said determined control parameters.

In an embodiment of the invention, the adjustable equalizer comprises a concatenation of a plurality of tunable optical filters.

Optionally, the tunable optical filters comprise a polarization adjuster and a differential delay for orthogonal polarizations. Optionally, the tunable optical filters comprise a polarization adjuster and a differential phase shifter for orthogonal polarizations, optionally also including a differential delay for orthogonal polarizations.

Optionally, the tunable optical filters comprise a beam splitter and a differential delay. Optionally, the tunable optical filters comprise a beam splitter and a different phase shifter for the split beams, optionally also including e a differential delay for the split beams.

In an embodiment of the invention, all of the channels received on the transmission link pass through the adjustable equalizer. Alternatively, the plurality of channels comprises fewer than all of the channels received on the transmission link. Optionally, the system includes at least one additional distortion correction apparatus, which is operative to adjust at least some of the other channels received on the transmission link.

In an embodiment of the invention, each additional distortion apparatus comprises:
an adjustable optical equalizer, through which a plurality of said channels pass;
a field sampler that samples signals passing through said equalizer, such that a plurality of channels passing through the adjustable equalizer are separately sampled; and
a controller that receives the samples, determines control parameters for the equalizer therefrom and adjusts the equalizer, responsive to said determined control parameters.

Optionally, the plurality of channels corrected by at least some of the distortion correction apparatus comprises 4 channels. Alternatively, the plurality of channels corrected by at least some of the distortion correction apparatus comprises 8 or 16 channels.

In an embodiment of the invention, the controller determines said control parameters by an iterative method. Alternatively or additionally, the controller determines said control parameters utilizing a neural network method.

In some embodiments of the invention, the method minimizes a cost function. In others it maximizes a cost function.

In some embodiments of the invention, the cost function is derived from signals passed on the individual channels.

In some embodiments of the invention the cost function is responsive to a quality of match between an actual pulse shape and an ideal pulse shape. Alternatively or additionally, it is responsive to a quality of match between an actual pulse shape and an undistorted pulse shape. Alternatively or additionally, it is responsive to a peak of pulses in the channels. Alternatively or additionally, the cost function is responsive to a BER in the respective channels. Alternatively or additionally, it is responsive to a Q factor for the respective channels. Alternatively or additionally, it is responsive to an eye opening for the respective channels.

Optionally, the cost function gives a higher weight to those channels that are further from desired values than to those that are closer to desired values.

Optionally, the controller determines initial control parameters responsive to measurements on a training sequence of pulses. Optionally, the controller sets initial control parameters to produce minimum changes in all of the channels. Optionally, the controller sets initial control parameters based on trial and error. Optionally, the controller sets initial control parameters responsive to known or assumed distortions in the transmission link.

In an embodiment of the invention, the controller updates the control parameters responsive to periodic sets of training pulses. Alternatively, the controller updates the control parameters responsive to actual data transmitted on the transmission link.

There is further provided, in accordance with an exemplary embodiment of the invention, dual path filter apparatus for correcting distortion on an optical transmission link carrying a multiplicity of optical transmission channels, the apparatus comprising:
an beam splitter that splits signals received from a transmission system into two paths, each having carrying substantially the same channels;
first correction apparatus that receives the signals from a first one of the paths comprising a first adjustable equalizer, an optical field sampler that samples signals passing through said equalizer and a controller that is operative to adjust the first adjustable equalizer, responsive to the sampled signals to ameliorate the distortion; and
second correction apparatus along the other path comprising a main line adjustable equalizer, substantially the same as the first adjustable equalizer through which a plurality of said channels pass;
wherein said controller adjusts parameters of said main line adjustable equalizer responsive to a desired compensation achieved in said first path.

Optionally, the first and/or second correction apparatus is an apparatus in accordance with the invention. Optionally, the first and second correction apparatus are of substantially the same construction.

### BRIEF DESCRIPTION OF FIGURES

Non-limiting examples of embodiments of the present invention are described below with reference to figures attached hereto and listed below. In the figures, identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1 schematically shows an optical fiber transmission link comprising a WAOE having TOFUs, in accordance with an embodiment of the present invention;

FIG. 2 shows a simplified flow chart for updating a WAOE, in accordance with an embodiment of the invention,

FIG. 3 shows a flow chart of an algorithm for updating control coefficients of the TOFUs comprised in the WAOE shown in FIG. 1, in accordance with an embodiment of the present invention.

FIG. 4 schematically shows an optical fiber transmission link having a separate path for testing corrections, in accordance with an embodiment of the invention; and

FIG. 5 schematically shows an optical fiber transmission link in which multiple sub-bands of channels are corrected, in accordance with an embodiment of the invention.

### DETAILED DESCRIPTION OF EXEMPLARY EMBODIMENTS

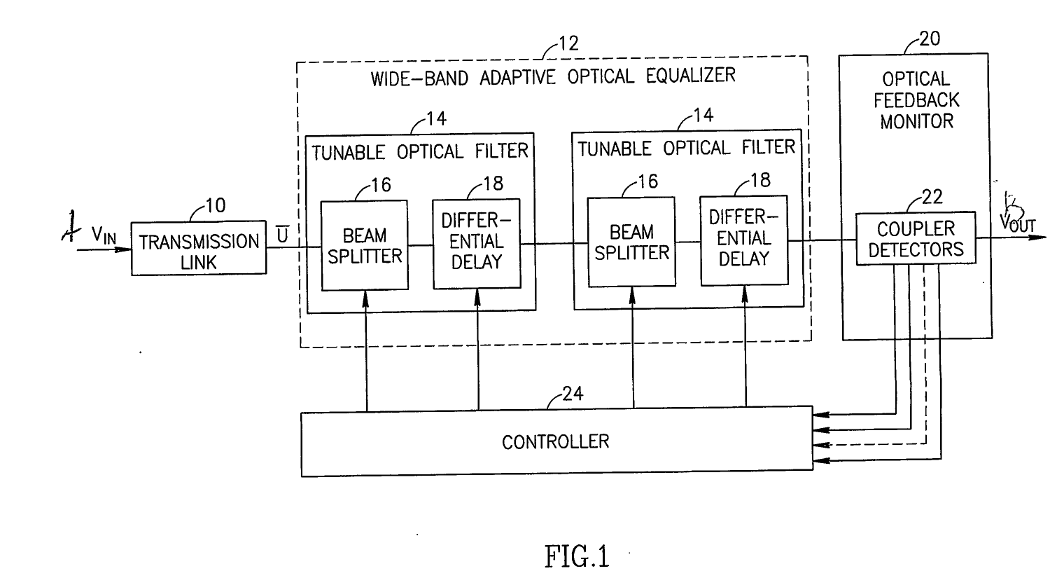

FIG. 1 schematically shows a multi-channel optical fiber transmission link 10 feeding a wideband adaptive optical equalizer (WAOE) 12. In the exemplary embodiment shown, WAOE 12 comprises a plurality of tunable optical filter units (TOFUs) 14, each of which comprises a beam splitter 16 and a differential delay element 18. Optionally, the beam splitter splits the beam based on the polarization of the beam. Alternatively, the splitting is not based on polarization. One or more TOFUs may also include a phase shifter (not shown). Differential delay element 18 is designed so that the delay caused by element 18 is different for different polarizations. Since a difference in time delay between the differently polarized waves is equivalent to a differential phase shift between the polarizations, these two concepts may be used interchangeably in the following discussion. The phase shifter and differential delay elements have substantially the same function, except that more controllable differences may be achievable if phase shifters are used. In some embodiments of the invention the differential delay element is tunable, i.e., the amount of the differential delay is can be adjusted as required to compensate for distortions along transmission link 10. In some embodiments of the invention, the differential delay is provided by a birefringent element, optionally one with a variable difference in path length.

In some embodiments of the invention, a coupler with variable coupling replaces the beam splitter and a different delay is provided for each output of the coupler. Various implementations will occur to persons of skill in the art which provide the goal of splitting and differentially delaying portions of the input.

In some embodiments of the invention the differential delay elements of all the TOFUs are aligned in such a way that if all the control parameters are at their nominal settings, then there is no differential delay between the two axes of polarization at the output of the equalizer and the equalizer can be considered as transparent.

An optical feedback monitor 20, including a multi-channel coupler 22, provides inputs to a controller 24, which adjusts the various couplers 16 and optional phase shifters and differential delay elements 18 to compensate for errors in the transmission along link 10.

As shown in FIG. 1, various fields (representing the signals at various points in the system are defined. In particular, the input to communications link 10 is Vᵢₙ, the input to equalizer 12 is (a vector) U and the output of the transmission link is Vₒᵤₜ. In general, more than two TOFUs are present, especially when many channels are corrected together.

The field at the input to the WAOE is given by the vector:
U=[Vₓ(t), V_{y}(t)]^{T}, (1)
where Vₓ and V_{y} are the field strengths for the orthogonal polarizations, and
U=[T]*Vin. (2)

[T] is the transmission matrix of transmission link 10. ([T] should not be confused with the superscript T which stands for transpose.)

A TOFU 14 can be represented by a concatenation of a rotation matrix,

$${R}_{i} = [ \begin{matrix}cos {θ}_{i} & - sin {θ}_{i} \\ sin {θ}_{i} & cos {θ}_{i}\end{matrix} ] \qquad ( 3 )$$

and a differential delay for the two polarizations represented by:

$${W}_{i} = [ \begin{matrix}δ ( t - {D}_{i} ) & 0 \\ 0 & δ ( t )\end{matrix} ] , \qquad ( 4 )$$

and the transmission matrix for the equalizer for an arbitrary number N of TOFUs in the equalizer may be expressed as:
T=W_{N}R_{N}*W_{N-1}R_{N-1} . . . W₂R₂*W₁R₁. (5)

Alternatively, the TOFU can be represented by a concatenation of a rotation matrix and a differential phase shifter. As indicated above, a differential phase shifter and a differential delay are equivalent.

It is noted that for the case of PMD distortion only, the TOFU construction described above is the inverse of the distortion from the transmission system and, in principle, with enough elements, the distortion can be reversed. In practice, however, a complete cancellation of even PMD is not possible since the parameters of the model for the transmission system are not known, vary with time and are functions of the channel number (wavelength). A second problem is that there are probably many different T matrices that can be used to represent the transmission of system 10. A third problem is that the exact form of Vin(t) may not be known and finally, that the form of U is a function of the wavelength band (i.e., of wavelength). A further problem is that the matching of the models of the WAOE and the transmission link is only the same for PMD distortion only and other distortions may be sizeable.

In exemplary embodiments of the invention, individual error indicators for a plurality of channels are defined. Exemplary definitions of such error indicators are described below. The individual error indicators can be expressed as a vector:
q=[q₁ . . . q_{K}]; k=1 . . . K; (6)
where K is the number of channels used in the equalization method. Ideally, all of the channels are used in the correction. However, for some systems, cost, convergence and/or response time may mandate using fewer than all of the channels. It is expected that the results using fewer than all the channels may provide results that are close to those using the full number of channels. Since the number of available TOFUs is limited, perfect correction is not generally possible in any event.

In some embodiments of the invention, all of the channels transmitted on the transmission system are equalized simultaneously. However, for some systems it may be preferably to simultaneously equalize only a portion of the whole transmitted band comprised in a sub-band. Typically, such a sub-band may comprise 4, 8, 16 or some other number of channels. In such a system, the band is split into such sub-bands which are then equalized, in accordance with apparatus and techniques of the present invention.

In some embodiments of the invention, a cost function, based on error indicators for individual channels is used to determine the “goodness” of the equalization. It should be noted that for systems in which multiple sources of distortion are present, the error indicators should be sensitive to all of the distortions that are to be corrected. However, a lesser correction can be achieved with error indicators that are sensitive to only some of the distortions.

In some embodiments of the invention, the cost function is a sum (or weighted sum) of the error indicators. In some embodiments of the invention, the cost function is a sum of the squares (or higher order function) of the error indicators. Such a higher order cost function gives a greater weight to those channels in which the error is larger and de-emphasizes (or ignores) the channels for which the error is smaller. This forces the system to search for a solution in which all of the channels are equally corrected. This can be emphasized further by utilizing only error indicators that are above some threshold. Optionally, only the difference from the threshold is used as the indicator. Other ways to form the cost function from error indicators that provide the similar results, will occur to persons of skill in the art.

In an embodiment of the invention, the signal at each of the channels (or at least a plurality of the channels) is compared to an idealized input signal. When the actual input signal is known, it can be used for the comparison. Alternatively, an appropriate signal shape is assumed or comparison is made with a δ function. Furthermore, since each of the signals is also attenuated (in addition to the phase distortion being corrected), the output signals may be normalized, in some embodiments of the invention, to correct for attenuation.

The form of the signals produced by the multi-channel coupler can (or at least their power spectrum), for example, be determined utilizing the methodology described in copending PCT application PCT/IL02/00165, referenced above. This signal (or spectrum) is then compared with the ideal signal (or spectrum) and a value representing the error is determined.

Alternatively, the actual signal is cross-correlated with the ideal signal and a cross-correlation value is determined. An appropriate individual channel error indicator qₖ is, for example the mean square difference between the actual pulse shape and the ideal pulse shape in one polarization. Alternatively, the couplers couple energy from both polarizations and the shape used for the comparison is the shape of the combined, coupled signal.

One useful individual channel error indicator is the peak value of the pulses in the channel. This factor is sensitive to all types of distortion. The peak value is maximized, with qₖ being 1-Vₚ, where Vₚ is the peak voltage normalized to 1 as described above. One can then form a scalar cost function as:

$$q = {\sum }_{1}^{K} {q}_{k}^{n} . \qquad ( 7 )$$

If n is odd, the absolute value of qₖ should be used.

As indicated above, n may be more than 1 to emphasize the channels for which the correction is poor. Use of higher order functions also is believed to minimize the effect of noise. As indicated above, alternatively to using all of the measured individual error indicators in the computation of the cost function, only those error indicators greater than some threshold value may be used. This threshold value could be lower than the threshold value for accepting a result as being good.

In some embodiments of the present invention, an error indicator is determined responsive to eye opening data for each channel. Alternatively or additionally it is responsive to a Q-factor derived from channel BER data. Optionally, the BER is measured by a component in the receiver, for example an FEC unit. Optionally, the BER signal itself forms the basis for the error indicator. Optionally, the error indicator is any measurement, process or calculated number that is monotonic with or correlated with the BER. Optionally, a partial BER (failure of detection of ones or zeros) is used as the basis for the error function.

In some embodiments of the present invention, an error signal is a measurement or processed signal that results from a correlation between any of the equalized signals and the unequalized signals. This method of determining error signals is described, for example in “Digital Communications”, by J. G. Proakis, Chapter 11, McGraw-Hill, N.Y., Fourth Edition, 2001.

In each of these embodiments multiple feedback signals are provided, one for each channel used in the correction.

It may be useful to use more than one comparison method in correcting the transmission. For example, when distortion is high, it may be difficult to use the peak voltage or eye opening methods, since these methods works best when the b 0s and 1s can be differentiated. Thus, a method that is sensitive only to PMD such as maximizing the power in one of the polarizations or a cross-correlation method may be used first and then one of the more shape specific methods may be used in order to keep the distortion low.

Alternatively to utilizing a scalar cost function aggregating the combined individual error indicators, a vector cost function as defined in equation 6 can be used. The control parameters of the system can be defined as a vector:
P=[p₁ . . . pₘ . . . p_{M}], (8)
where in is the index of the control parameter which varies from 1 to M the number of controlled parameters. For instance, if there are N TOFUs and both rotation (or splitting) and differential delay or phase shift are controlled variables for each TOFU, then M=2N. If the differential delays are fixed, then N=M. If both delay and phase shift are controlled in addition to rotation or splitting, M=3N.

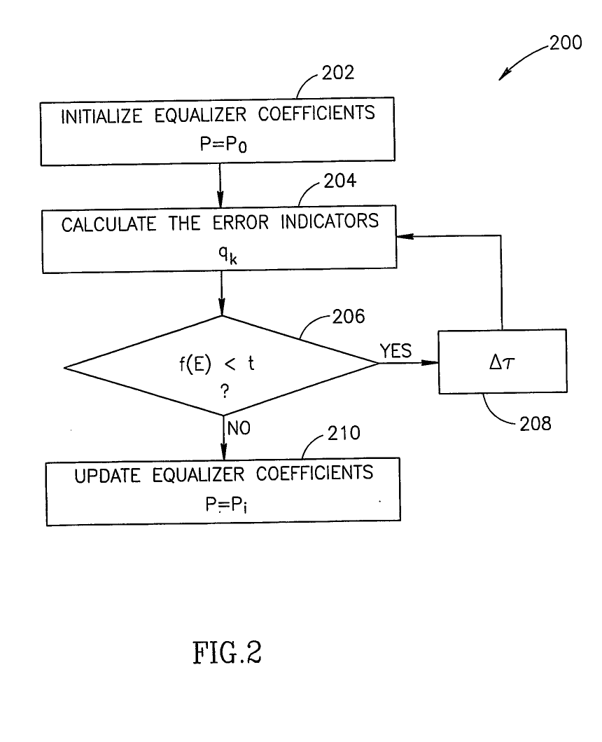

FIG. 2 shows a general flow-chart 200 for a correction scheme according to an embodiment of the invention. The coefficients of the correction vector P defined above are first set to some initial condition at 202. The error functions, q, for each of the channels is determined at 204. If there is some knowledge of the distortion of the transmission system, the initial condition is set as a first guess for correction, responsive to the known distortion. Otherwise, an arbitrary initial condition or one which adds as little distortion as possible is used.

The cost function C=f(E), which is a function of the qₖs, is compared to a threshold at 206. If the cost function is less than some threshold value t, the process waits some time τ (208) and then checks the error function again to see if it has deteriorated from the previous measurement.

If the cost function has a larger value than the threshold, then a search is performed to find a value of P which reduces the value of the error function. This is referred to as updating the correction vector P (at 210). Following updating the calculation of the error functions (204) is performed for the updated coefficients. This process continues until the error function drops below the threshold.

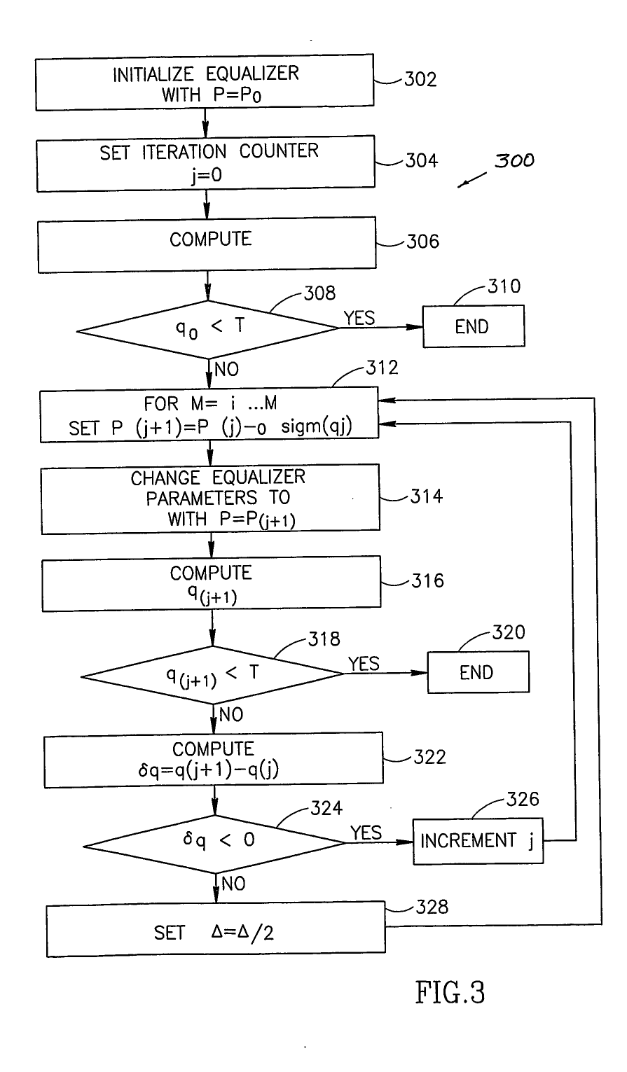

FIG. 3 shows a more detailed general flowchart 300 for the equalization of the system in accordance with an exemplary embodiment of the invention. The equalizer is initialized (302) and an iteration counter is set to zero (304) and an initial value of q is computed (306). This initial value is compared to a threshold (208), depending on the form of q that was determined. It should be noted that if q is a scalar, the threshold is generally a scalar value. If q is a vector, the thresholding operation may be performed on each of the elements separately, with an acceptable solution being a sum of individual error functions (or functions of the error functions) being below a given value or that each of the individual error functions be below a threshold.

If the value is less than the threshold (or, more generally, if the threshold condition is met), the process is ended (310), if not, the process continues. For each value of m (namely for each control parameter) the parameter is incremented or reduced (312) by a value Δ with a sign that is the opposite of the rate of change of Q with respect to pₘ. Alternatively, a maximum slope of the change of Q with P may be used. Such maximum slope methods are well known in the art.

The equalizer parameters are changed to the new values (314) and a new value of q is determined (316) and compared to the threshold (318). As with comparison 308, if the value of q is below the threshold, the process is ended (320), otherwise the value of q is compared with the previous value of q (322 and 324). If q is lower than the previous q, the iteration number is increased by one (326) and the control parameters are corrected again. Otherwise, the increment is cut in half (328) and the control parameters are corrected again. This process continues until q<T, a threshold value.

One problem with this method is that the derivatives are not known, since the functional variation in q with the pₘs and with channel number is not known. What is known is the output field Vₒᵤₜ and the current state of the transfer function (matrix) of WAOE 12. This transfer matrix of the WAOE can be determined either analytically or experimentally. The analytic function is complex, due to the large number of variables (including frequency), but it can be determined in a numerical form (i.e., in the form of a multidimensional table) which can be used to determine the derivatives. Variables in this table include, in addition to wavelength, each of the pₘ control values. Similarly, the multidimensional table can be derived experimentally, by performing a large number of experiments to generate a look-up table. A combination of experimental results and analytic derived interpolation may also be used. In general, the output can be related to the input by:
Vₒᵤₜ=TVᵢₙ, and (9)
Vᵢₙ=T⁻¹Vₒᵤₜ. (10)

For any of the cost functions described, it is possible to compute the derivatives of q from the output voltages and from the knowledge of T at each value of pₙ. Iterative search methods such as that shown in FIG. 3 and alternatives therefor for complex systems are known and other methods for searching for minimum Q will occur to persons of skill in the art, as will methods of avoiding relative minima and other problems with such search methods.

Alternatively, the control variables are changed one at a time. If a change in a first direction reduces the power, then keep it. Otherwise try the other direction. If it helps, keep it. If neither helps, leave it alone. Go on to the next control variable.

If 10 symbols are needed to get a meaningful indication and there are 10 control variables, then at most 300 symbols are needed to perform one iteration. At high symbol rates, this can be performed quickly.

Alternatively or additionally, the initial control parameter values are determined by trying a number of random or quasi random values and picking the one with the lowest error function value as the starting point. This can be useful in complex systems.

In some embodiments of the invention, the coefficients are determined using neural network techniques.

In some embodiments of the invention, the coefficients are updated according to LMS, RLS or LS type algorithms. Such algorithms are known in the art.

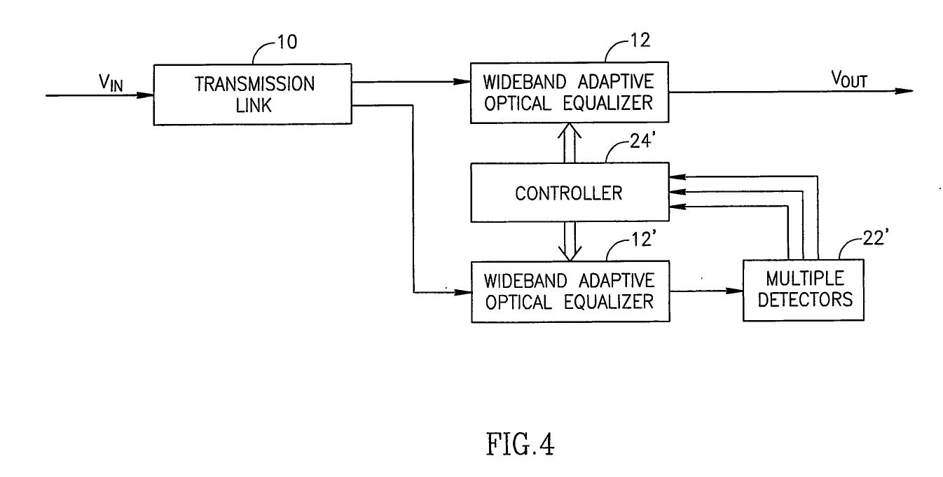

In FIG. 1, a system is shown in which the coupler/feedback monitor 20 is in the “main line” of the system. FIG. 4 shows an alternative system in which the control parameters are first tested against a side line and the main line equalizer is controlled only when a sufficiently better result is obtained. Other forms of such dual path filters will occur to persons of skill in the art.

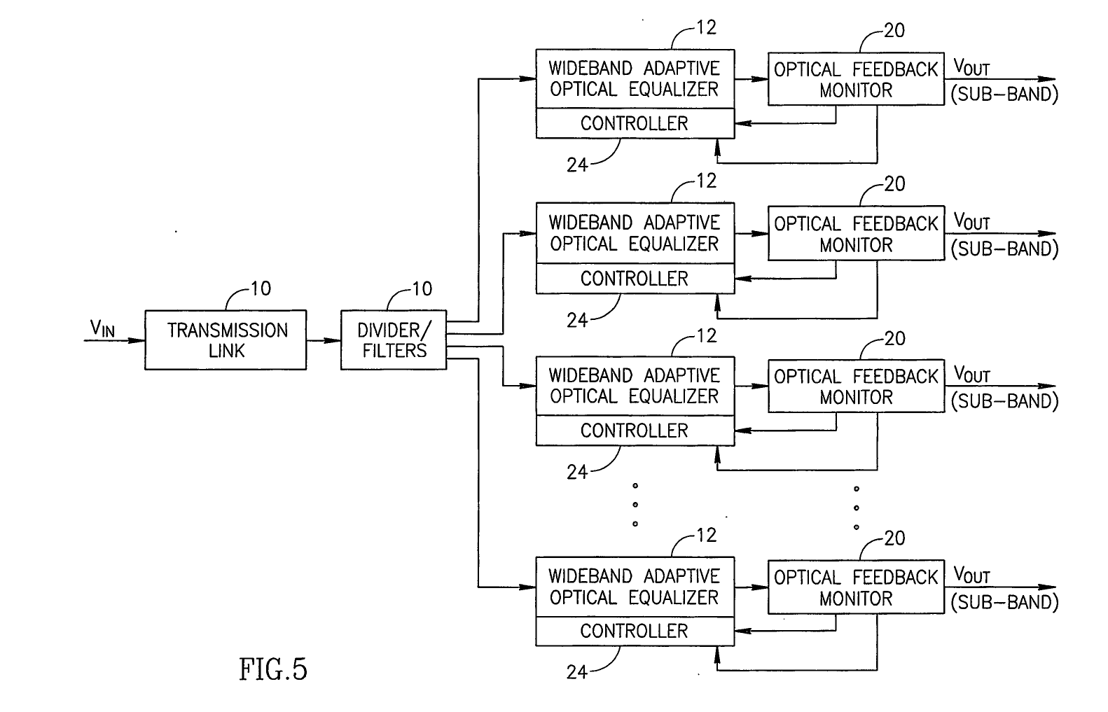

FIG. 5 shows a system in which the total band of input channels is split into multiple sub-bands, each containing 4, 8, 16 or more channels. While this requires more hardware than the structure of FIG. 1, the iterative algorithms described above can be expected to converge more quickly for the apparatus shown in FIG. 5 than for the apparatus of FIGS. 1 or 4. When multiple channels are corrected together, the saving in hardware is still significant over that shown in the prior art.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. Apparatus for correcting distortion on an optical transmission link carrying a multiplicity of optical transmission channels, the apparatus comprising:
an adjustable optical equalizer, through which a plurality of said channels pass;
a field sampler that samples signals passing through said equalizer, such that a plurality of channels passing through the adjustable equalizer are separately sampled; and
a controller that receives the samples, determines control parameters for the equalizer therefrom and adjusts the phase or time delay of at least one element of the equalizer, responsive to said determined control parameters.

2. Apparatus according to claim 1 wherein the adjustable equalizer comprises a concatenation of a plurality of tunable optical filters.

3. Apparatus according to claim 2 wherein the tunable optical filters comprise a polarization adjuster and a differential delay for orthogonal polarizations.

4. Apparatus according to claim 2 wherein the tunable optical filters comprise a polarization adjuster and a differential phase shifter for orthogonal polarizations.

5. Apparatus according to claim 4 wherein the tunable optical filters also include a differential delay for orthogonal polarizations.

6. Apparatus according to claim 2 wherein the tunable optical filters comprise a beam splitter and a differential delay.

7. Apparatus according to claim 2 wherein the tunable optical filters comprise a beam splitter and a different phase shifter for the split beams.

8. Apparatus according to claim 7 wherein the tunable optical filters also include a differential delay for the split beams.

9. Apparatus according to claim 1 wherein all of the channels received on the transmission link pass through the adjustable equalizer.

10. Apparatus according to claim 1 wherein the plurality of channels comprises fewer than all of the channels received on the transmission link.

11. Apparatus according to claim 10 and including at least one additional distortion correction apparatus, which is operative to adjust at least some of the other channels received on the transmission link.

12. Apparatus according to claim 11 wherein each additional distortion apparatus comprises:
an adjustable optical equalizer, through which a plurality of said channels pass;
a field sampler that samples signals passing through said equalizer, such that a plurality of channels passing through the adjustable equalizer are separately sampled; and
a controller that receives the samples, determines control parameters for the equalizer therefrom and adjusts the equalizer, responsive to said determined control parameters.

13. Apparatus according to claim 10 wherein the plurality of channels corrected by at least some of the distortion correction apparatus comprises 4 channels.

14. Apparatus according to claim 10 wherein the plurality of channels corrected by at least some of the distortion correction apparatus comprises 8 channels.

15. Apparatus according to claim 10 wherein the plurality of channels corrected by at least some of the distortion correction apparatus comprises 16 channels.

16. Apparatus according to claim 1 wherein the controller determines said control parameters by an iterative method.

17. Apparatus according to claim 1 wherein the controller determines said control parameters utilizing a neural network method.

18. Apparatus according to claim 16 wherein said method minimizes or maximizes a cost function.

19. (canceled)

20. Apparatus according to claim 18 wherein the cost function is derived from signals passed on the individual channels.

21. Apparatus according to claim 20 wherein the cost function is responsive to a quality of match between an actual pulse shape and an ideal pulse shape.

22. Apparatus according to claim 20 wherein the cost function is responsive to a quality of match between an actual pulse shape and an undistorted pulse shape.

23. Apparatus according to claim 20 wherein the cost function is responsive to a peak of pulses in the channels.

24. Apparatus according to claim 20 wherein the cost function is responsive to a BER in the respective channels.

25. Apparatus according to claim 20 wherein the cost function is responsive to a Q factor for the respective channels.

26. Apparatus according to claim 20 wherein the cost function is responsive to an eye opening for the respective channels.

27. Apparatus according to claim 18 wherein the cost function gives a higher weight to those channels that are further from desired values than to those that are closer to desired values.

28. Apparatus according to claim 1 wherein the controller determines initial control parameters based on measurements on a training sequence of pulses.

29. Apparatus according to claim 1 wherein the controller sets initial control parameters to produce minimum changes in all of the channels.

30. Apparatus according to claim 1 wherein the controller sets initial control parameters based on trial and error.

31. Apparatus according to claim 1 wherein the controller sets initial control parameters based on known or assumed distortions in the transmission link.

32. Apparatus according to claim 1 wherein the controller updates the control parameters based on periodic sets of training pulses.

33. Apparatus according to claim 1, wherein the controller updates the control parameters based on actual data transmitted on the transmission link.

34. Dual path filter apparatus for correcting distortion on an optical transmission link carrying a multiplicity of optical transmission channels, the apparatus comprising:
an beam splitter that splits signals received from a transmission system into two paths, each having carrying substantially the same channels;
first correction apparatus that receives the signals from a first one of the paths comprising a first adjustable equalizer, an optical field sampler that samples signals passing through said equalizer and a controller that is operative to adjust the first adjustable equalizer, responsive to the sampled signals to ameliorate the distortion; and
second correction apparatus along the other path comprising a main line adjustable equalizer, substantially the same as the first adjustable equalizer through which a plurality of said channels pass;
wherein said controller adjusts parameters of said main line adjustable equalizer responsive to a desired compensation achieved in said first path.

35. Apparatus according to claim 34 wherein at least one of the first correction apparatus is an apparatus in accordance with claim 1.

36. (canceled)

37. Apparatus according to claim 35 wherein the first and second correction apparatus are substantially of the same construction.
